(19) United States
(12) Patent Application Publication
(10) Pub. No.: US 2013/0230288 A1
(43) Pub. Date: Sep. 5, 2013

(54) OPTICAL FIBER

(71) Applicant: YU-CHAO HSIAO, Tu-Cheng (TW)

(72) Inventor: YU-CHAO HSIAO, Tu-Cheng (TW)

(73) Assignee: HON HAI PRECISION INDUSTRY CO., LTD., Tu-Cheng (TW)

(21) Appl. No.: 13/478,129

(22) Filed: May 23, 2012

(30) Foreign Application Priority Data
Mar. 2, 2012 (TW) 101106855

(51) Int. Cl. G02B 6/02

(52) U.S. Cl. 385/123

(57) ABSTRACT

An optical fiber for use with a light source is illustrated. The optical fiber includes a main body with a cylindrical lateral surface and an end. The end includes an end surface substantially perpendicular to an axis of the main body and a convex connecting surface between the lateral surface and the end surface, thereby increasing incident angles of the light rays that refracted into the main body through the connecting surface.

### BACKGROUND

1. Technical Field

The present disclosure relates to an optical fiber capable of minimizing the light loss due to leakage from lateral surface of the optical fiber.

2. Description of Related Art

Fiber-optic communication is a method of transmitting information through an optical fiber. The optical fiber is used with a light source, and the light source emits light into the optical fiber that is modulated to carry information. Only entered light rays that have incident angles greater than a predetermined critical angle can travel down the optical fiber without leaking out. It is important to maximize the amount of light rays that have incident angles greater than the critical angle. Therefore, a new type of optical fiber with less leaking out is needed.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an isometric view of an optical fiber according to an exemplary embodiment.

FIG. 2 is a cross sectional view of the optical fiber of FIG. 1, taken along an optical axis X of the optical fiber.

FIG. 3 is a schematic view of the optical fiber being used with a light source.

### DETAILED DESCRIPTION

Embodiments of the present disclosure are now described in detail, with reference to the accompanying drawings.

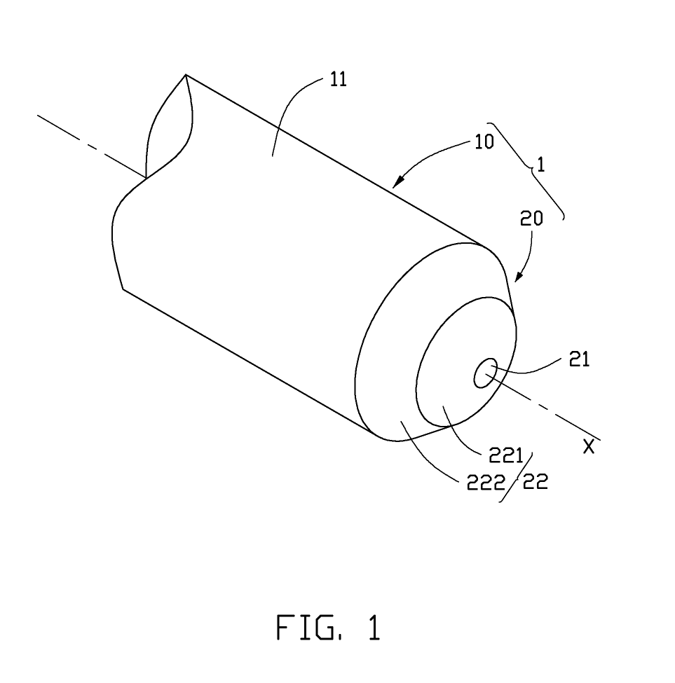

Referring to FIG. 1, an optical fiber 1 according to an exemplary embodiment is illustrated. The optical fiber 1 includes a main body 10 for totally internally reflecting light rays therein. The main body 10 includes an end 20 that light rays enter.

The main body 10 includes a cylindrical lateral surface 11. In the embodiment, the optical fiber 1 is a single mode fiber, and a portion of the end 20 is cut off by a laser cutting machine, which forms a convex connecting surface 22 and an end surface 21.

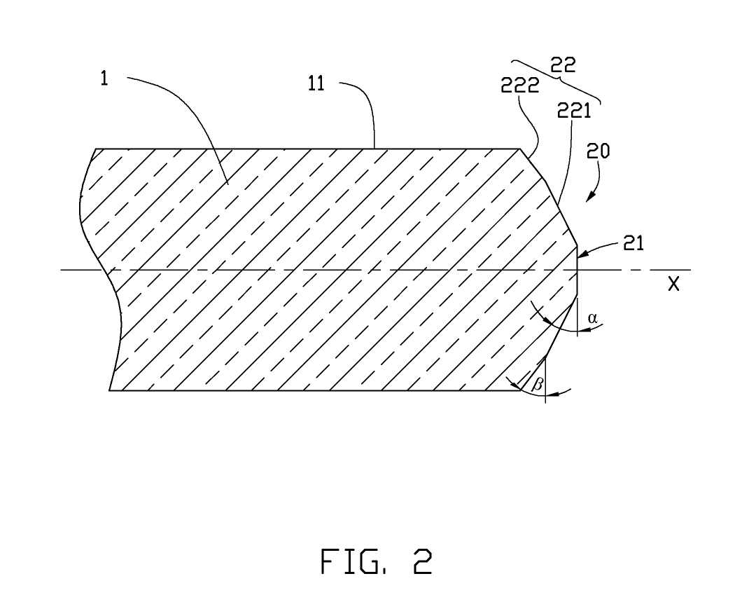

Referring also to FIG. 2, the end surface 21 is substantially perpendicular to an optical axis X of the main body 10. The connecting surface 22 includes a first inclined annular surface 221 connected and surrounding to the end surface 21 and a second inclined annular surface 222 between the lateral surface 11 and the first surface 221. A first angle α is defined between the first surface 221 and the end surface 21. A second angle β is defined between the second surface 222 and the end surface 21. In the embodiment, the first angle a is less than the second angle β.

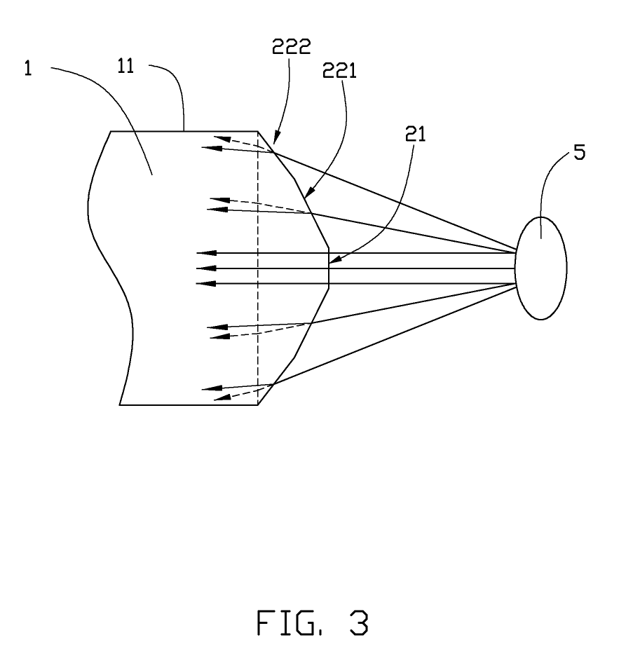

Referring also to FIG. 3, the solid lines shows the optical fiber 1 that is used with a light source 5, and the broken lines shows a conventional optical fiber that is used with the light source 5. The light source 5 can be a light emitting diode (LED) light source. The light source 5 emits light rays into the optical fiber 1. Comparing with the conventional fiber, it is clear that the light rays that are refracted into the main body 10 through the first surface 221 and the second surface 222 have greater incident angles, thereby maximizing the amount of light rays that have incident angles greater than the predetermined critical angle. The incident angles are measured between the broken line that is perpendicular to the lateral surface 11 and the light rays refracted into the end 20. Thus, the optical fiber 1 coupled to the light source 5 can minimize light loss due to leakage from the lateral surface 11.

While various embodiments have been described and illustrated, the disclosure is not to be constructed as being limited thereto. Various modifications can be made to the embodiments by those skilled in the art without departing from the true spirit and scope of the disclosure as defined by the appended claims.

What is claimed is:

1. An optical fiber, comprising:
a main body comprising a cylindrical lateral surface and an end, wherein the end comprises an end surface substantially perpendicular to an optical axis of the main body and a convex connecting surface between the lateral surface and the end surface, thereby increasing incident angles of the light rays that are refracted into the main body through the connecting surface.

2. The optical fiber as described in claim 1, wherein the optical fiber is a single mode fiber.

3. The optical fiber as described in claim 1, wherein the end is cut by a laser cutting machine that thus forms the convex connecting surface.

4. The optical fiber as described in claim 1, wherein the convex connecting surface comprises a first inclined annular surface connected and surrounding to the end surface, and a second inclined annular surface connected between the lateral surface and the first inclined annular surface.

5. The optical fiber as described in claim 4, wherein a first angle a is defined between the first surface and the end surface, and a second angle β is defined between the second surface and the end surface, and the first angle α is less than the second angle β.
